(19) United States
(12) Patent Application Publication
(10) Pub. No.: US 2014/0188703 A1
(43) Pub. Date: Jul. 3, 2014

(54) STREAMLINED TRAVEL PAYMENTS

(71) Applicants: Wing Fung Tse, Jakarta (ID); Takatsugu Terachi, Singapore (SG)

(72) Inventors: Wing Fung Tse, Jakarta (ID); Takatsugu Terachi, Singapore (SG)

(21) Appl. No.: 13/731,626

(22) Filed: Dec. 31, 2012

(51) Int. Cl. G06Q 20/08

(52) U.S. Cl. CPC G06Q 20/08; G06Q 20/108
USPC 705/39; 235/375

(57) ABSTRACT

Systems and methods for making payments during travel are described. The methods include receiving payment instructions for a plurality of predetermined locations associated with a plurality of merchants, determining a location of a user, automatically transmitting a payment request when the user is within a predetermined distance of one of the predetermined locations, receiving a payment confirmation from the user, and processing the payment request.

### BACKGROUND

1. Field of the Invention

The present invention generally relates to facilitating the payment of merchants during travel.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

People are traveling farther and more often for business and pleasure. Frequently, multiple travel arrangements, such as flight, car, and hotel reservations are made. There are multiple stops a traveler must make between his original location and final destination. Thus, there is a need for methods and systems that facilitate the payment for goods and services at each stop a traveler makes.

### BRIEF DESCRIPTION OF THE FIGURES

FIG. 1 is a is a block diagram of a networked system suitable for implementing the methods described herein according to an embodiment;

FIG. 2 is a flowchart showing a method of making payments during travel according to one embodiment; and

FIG. 3 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for simplifying payments a traveler makes during a trip. A traveler makes different reservations for different points along his trip. The traveler inputs a payment instruction, which designates a user account and a payment location. Alternatively, when the user makes the reservations, a payment service provider can automatically input the payment instruction for the user. When a mobile device that is associated with the user account is determined to be in the payment location, a payment request to make a payment from the user account to the payee account is sent over a network. A payment time period may be associated with the payment location of the payment instruction to further specify when the payment should be made. The system and method allow a traveler, to make payments to a merchant by simply being in a predetermined location at a predetermined time.

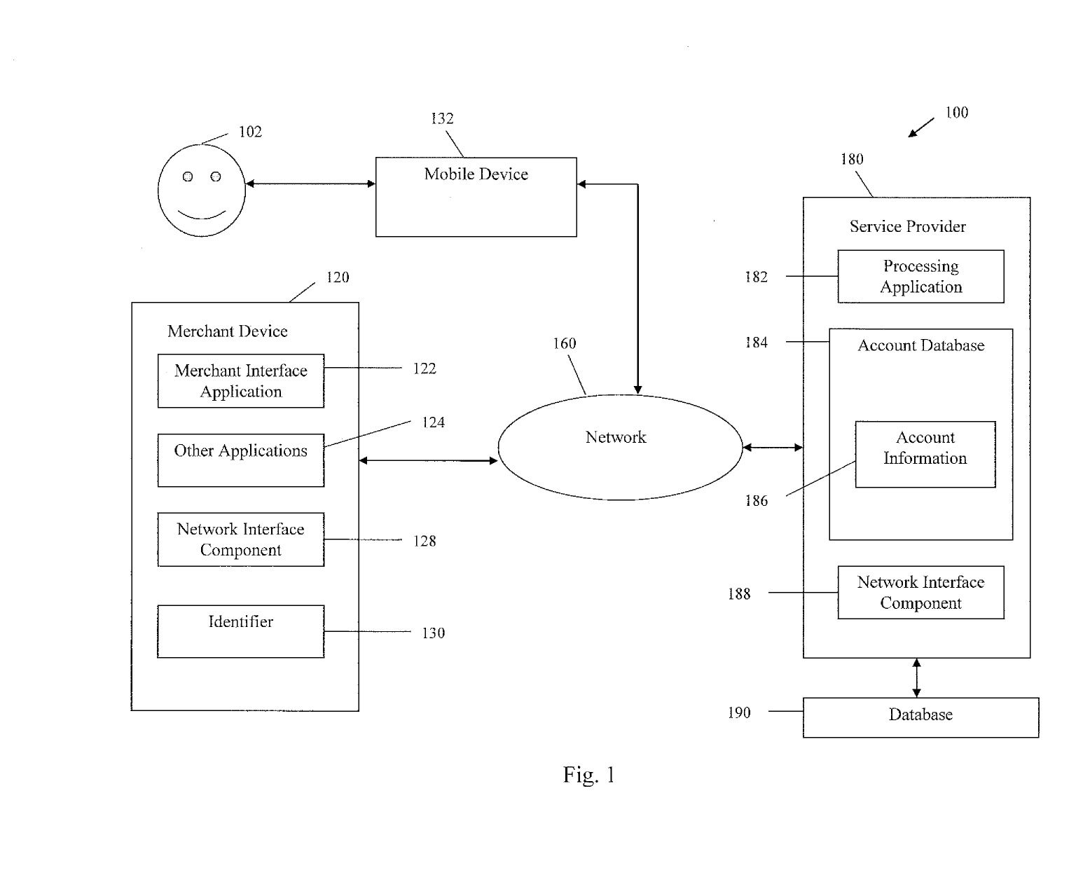

FIG. 1 illustrates an exemplary embodiment of a network-based system 100 for implementing one or more processes described herein over a network 160. As shown, network-based system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities. As shown in FIG. 1, the system 100 includes at least one mobile device 132, at least one merchant device 120, and at least one service provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., mobile cellular phone network) adapted to communicate with other communication networks, such as the Internet.

The merchant device 120, in various embodiments, may be implemented using any appropriate combination of hardware and/or software configured for wired and/or wireless communication over the network 160. In various examples, the merchant device 120 may be implemented as a wired and/or wireless communication device (e.g., an automated user interface device) for a user 102 (e.g., a client or customer) to communicate with the network 160, such as the Internet and/or mobile network.

The merchant device 120 may be maintained, for example, by a conventional or on-line merchant, conventional or digital goods seller, individual seller, and/or application developer offering various products and/or services in exchange for payment to be received conventionally or over the network 160. In this regard, the merchant device 120 may include a database identifying available products and/or services (e.g., collectively referred to as items) which may be made available for viewing and purchase by the user 102.

The merchant device 120 also includes a checkout application which may be configured to facilitate the purchase by user 102. The checkout application may be configured to accept payment information from the user 102 through the mobile device 132 and/or from the service provider through service provider server 180 over the network 160.

The merchant device 120 includes one or more merchant interface applications 122, which may be used by a merchant to contact the user 102 over the network 160. In one implementation, the merchant interface application 122 comprises a software program, such as a graphical user interface (GUI), executable by a processor that is configured to interface and communicate with the one or more service provider servers 180 via the network 160.

The merchant device 120, in various embodiments, may include one or more other applications 124 to provide additional features to the merchant. For example, these other applications 124 may include security applications for implementing client-side security features, programmatic client applications for interfacing with appropriate application programming interfaces (APIs) over the network 160 or various other types of generally known programs and/or applications.

The merchant device 120, in one embodiment, may include at least one network interface component (NIC) 128 adapted to communicate with the network 160. In various examples, the network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The merchant device 120, in one embodiment, may include one or more identifiers 130, which may be implemented as operating system registry entries, cookies associated with the merchant interface application 122, identifiers associated with hardware of the merchant device 120, and/or various other appropriate identifiers. The identifier 130 may include attributes related to the merchant device 120, such as identification information (e.g., a system serial number, a location address, Global Positioning System (GPS) coordinates, a network identification number, etc.) and network information (e.g., network owner, network provider, network administrator, network security information, etc.). In various implementations, the identifier 130 may be passed with network traffic data and information to the service provider server 180, and the identifier 130 may be used by the service provider server 180 to associate one or more network transactions of the user 102 with one or more particular user accounts maintained by the service provider server 180.

The mobile device 132, in one embodiment, may be utilized by the user 102 to interact with the service provider server 180, over the network 160. For example, the user 102 may log in to a mobile application run by the service provider via the mobile device 132. In various implementations, the mobile device 132 may include at least one of a wireless cellular phone, personal digital assistant (PDA), satellite phone, smartphone, mobile phone, etc.

In various implementations, a user profile may be created using data and information obtained from cellular phone activity over the network 160. Cellular phone activity transactions may be used by the service provider server 180 to create at least one user profile for the user 102 based on activity from the mobile device 132. The user profile may be updated with each financial and/or information transaction (e.g., payment transaction, purchase transaction, etc.) achieved through use of the mobile device 132. In various aspects, this may include the type of transaction and/or the location information from the mobile device 132. As such, the profile may be used for recognizing patterns of potential fraud, setting transaction limits on the user, etc.

The mobile device 132, in one embodiment, may include a user identifier as one or more attributes related to the user 102, such as personal information (e.g., a user name, password, photograph image, biometric id, address, social security number, phone number, email address, etc.) and banking information (e.g., banking institution, credit card issuer, user account numbers, security information, etc.). In various implementations, the user identifier may be passed with network traffic data of the user 102 to the service provider server 180, and the user identifier may be used by the service provider server 180 to associate the user 102 with a user account maintained by the service provider server 180.

In various implementations, the user 102 is able to input data and information into an input component (e.g., a keyboard) of the mobile device 132 to provide user information with a payment instruction, such as merchant name, payment location, etc. The user information may include user identification information.

The mobile device 132, in one embodiment, includes a geo-location component adapted to monitor and provide an instant geographical location (i.e., geo-location) of the mobile device 132. In one implementation, the geo-location of the mobile device 132 may include global positioning system (UPS) coordinates, zip-code information, area-code information, street address information, and/or various other generally known types of geo-location information. In one example, the geo-location information may be directly entered into the mobile device 132 by the user 102 via a user input component, such as a keyboard, touch display, and/or voice recognition microphone. In another example, the geo-location information may be automatically obtained and/or provided by the mobile device 132 via an internal or external GPS monitoring component. In one aspect, when interfacing with the mobile device 132, the user 102 may elect to provide or may be prompted to provide permission for the release of geo-location information. Accordingly, the user 102 may have exclusive authority to allow transmission of geo-location information from the mobile device 132 to the one or more merchant devices 120 and/or the service provider server 180. In any instance, the one or more merchant devices 120 and/or the service provider server 180 may communicate with the mobile device 132 via the network 160 and request permission to acquire geo-location information from the mobile device 132 for geo-location based mobile commerce.

The service provider server 180, in various embodiments, may be maintained by an online service provider. The service provider server 180 includes at least one processing application 182, which may be adapted to interact with the merchant device 120 and the mobile device 132 via the network 160 to facilitate the provision of goods/services and notification to the user 102. In one example, the service provider server 180 may be provided by PayPal, Inc. of San Jose, Calif., USA.

The service provider server 180, in one embodiment, may be configured to maintain a plurality of user accounts in an account database 184, each of which may include account information 186 associated with individual users, including the user 102. For example, account information 186 may include payment instructions to certain merchants along a predetermined route of travel. In another example, account info cation 186 may include identification information and/or private financial information of the user 102, such as account numbers, identifiers, passwords, phone numbers, credit card information, banking information, or other types of financial information. It should be appreciated that the methods and systems described herein may be modified to accommodate users that may or may not be associated with at least one existing user account.

The service provider server 180, in various embodiments, may include at least one network interface component (NIC) 188 adapted to communicate with the network 160 including the network interface component 128 of the merchant device 120 and the mobile device 132. In various implementations, the network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The service provider server 180, in various embodiments, may include one or more databases 190 (e.g., internal and/or external databases) for storing and tracking information related to users, such as payment requests and financial transactions of the user 102. For example, the databases 190 may provide a historical survey of financial transactions between the user 102 and the service provider 180. As such, in one implementation, the processing application 182 may be configured to track, log, store, and access financial transaction information and provide this information to the processing application 182 for analysis and maintenance.

The database 190 may also store, for example, address data for calling the mobile device 132. The address data may include data for communicating a text message to the mobile device 132, an e-mail address at which messages are receivable by the mobile device 132, or any other manner for communicating with the mobile device 132 so as to enable notification of the user 102 when the user is in a payment location. Moreover, service provider server 180 may include computer executable instructions that are operative to cause the server 180 to generate message content appropriate for messages to be communicated to the mobile device 132.

In various embodiments, the merchant device 120, the mobile device 132 and the service provider server 180 may be associated with a particular link (e.g., a link, such as a URL (Uniform Resource Locator) to an IP (Internet Protocol) address). In this regard, the user 102 may interface with the mobile device 132 via the network 160 to facilitate notification by the service provider server 180, which is discussed in greater detail herein.

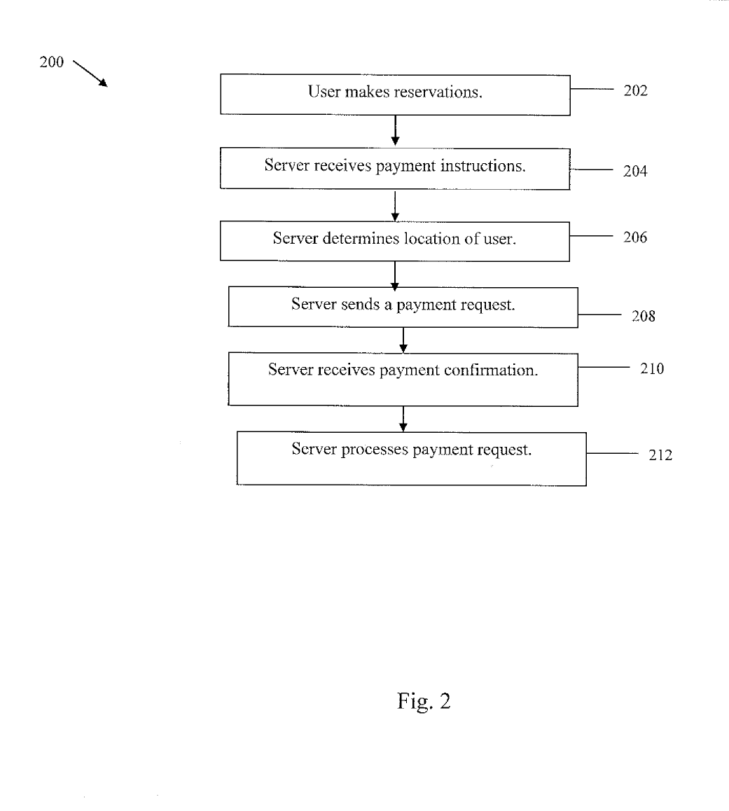

Referring now to FIG. 2, a method 200 for making payments during travel is illustrated. In the embodiment of the method 200 described below, a service provider provides user 102 with a user account, and the user 102 may use the user account to fund payments for purchases made to merchant payees. The service provider may be, for example, PayPal, Inc. of San Jose, Calif., which assists in the making of payments from the user 102 to the merchant by transferring funds from the user account to a merchant account. However, these embodiments are meant to be merely exemplary, and one of skill in the art will recognize that a variety of modifications may be made to the payment system discussed herein without departing from the scope of the present disclosure.

The method 200 begins at block 202 where user 102 makes reservations for different goods and/or services along a predetermined route of travel. For example, user 102 may decide to travel from California to Hawaii. User 102 makes a reservation for a flight from Los Angeles International Airport (LAX) to Honolulu International Airport (HNL). Besides the flight, user 102 also books a room at a hotel in Honolulu and reserves a rental car at the airport. User 102 also anticipates having dinner before arriving at the hotel so he makes a dinner reservation at a local restaurant.

At block 204, the service provider receives a payment instruction from user 102 regarding the predetermined locations along his route of travel. The payment instruction is associated with user 102′s account, a merchant, and a payment location. In an embodiment, user 102 uses mobile device 132, to access his account over network 160 (e.g., the Internet) by connecting to service provider server 180 of the service provider. In another embodiment, user 102 may enter each merchant's name, address, e-mail, phone number, etc.

In one embodiment, user 102 may be presented with a location provision page for the payment instruction. The location provision page may include a location input and a map indicator. In an embodiment, the location input allows user 102 to key in a payment location. For example, user 102 may enter in a merchant name, an address, and/or a variety of other location information known in the art to indicate a location at which user 102 would like a payment to be made. In an embodiment, upon keying the payment location into the location input, a payment location indicator may be displayed on the map indicator to indicate to user 102 where on the map the payment location that was keyed into the location input is located.

In another embodiment, user 102 may use the map indicator to select a payment location. For example, mobile device 132 may be a touch sensitive device, and user 102 may select the payment location indicator using a method known in the art (e.g., touching mobile device 132 at the desired payment location on the map indicator, “dropping a pin” on the map indicator and manipulating “the pin” with a finger to the desired payment location, selecting an area on the map indicator, etc.).

When user 102 has provided the payment location, user 102 may then submit the payment instruction to the service provider. While a number of embodiments of a payment location selection process have been described for providing a payment location to make payments, such embodiments are merely exemplary, and one of skill in the art will understand that a variety of other payment location selections processes will fall within the scope of the present disclosure.

In an embodiment, the payment instruction may include associated payment details that may be selected by user 102 and applied to the payment instruction. Such payment details page may include a payment amount detail, a payment time period detail, a payment location proximity detail, a pay automatically detail, and a request confirmation before paying detail. User 102 may associate payment details with the payment location provided in the payment instruction.

For example, if user 102 wishes to make a payment, user 102 may enter a payment amount (e.g., $25) in a payment amount input of the payment amount detail. If user 102 wishes to automatically make a payment only at certain times that user 102 is located in the payment location, the payer may modify time period inputs in the payment time period detail to include specific times for payment. If user 102 wishes to adjust the sensitivity of the payment location, user 102 may modify a proximity input in the payment location proximity details, such that payments will be attempted when mobile device 132 is within, e.g., 50 ft of the payment location. Alternatively, the proximity input may include a default value. If user 102 wishes for payments to be made automatically (e.g., in response to the automatic payment request being satisfied and no further confirmation from user 102), user 102 may select the pay automatically detail. If user 102 wishes for a confirmation to be requested before making a payment, user 102 may select the request confirmation before paying detail. User 102 may then submit the payment instruction to associate the payment details with the payment location.

One of skill in the art will recognize how combinations of the payment details may be applied to the payment location discussed above to precisely define how payment is to be made. Furthermore, the payment details discussed above are meant to be merely exemplary, and one of skill in the art will recognize how a variety of other payment details may be provided to further define how and when the payment should be made without departing from the scope of the present disclosure.

Once the payment instruction is received, user 102 is ready to make predetermined travel stops during his trip. As user 102 travels from one location to another, the method 200 proceeds to block 206 where the location of user 102 is determined. Mobile device 132 includes a location determination device (e.g., a Global Positioning System (GPS) device, a cell tower triangulation system device, and/or a variety of other location determination devices known in the art) that is operable to determine a current location of mobile device 132 that may be used to trigger a payment according to the payment instruction discussed above. That current location may be determined, for example, by using location data received from a location determination device.

For example, the location determination device on mobile device 132 may determine a current location of mobile device 132 and that current location may be compared with the payment locations stored in mobile device 132 and associated with the payment instructions to determine that mobile device 132 is in a payment location. In another example, the location determination device on mobile device 132 may determine a current location of mobile device 132 and that current location may be sent over network 160 to service provider server 180 to be compared with the payment locations associated with payment instructions in the database to determine that mobile device 132 is in a payment location. In an embodiment, mobile device 132 may be determined to be in a payment location associated with a payment instruction if mobile device 132 is within a predetermined distance of the payment location (e.g., according to the payment location proximity detail discussed above.) In another embodiment, the location determination device may determine first location data for a current location of mobile device 132, and that first location data may be compared to second location data for a payment location that is associated with a payment instruction to determine that the first location data corresponds to the payment location. In an embodiment, the first location data may be determined to be in a payment location associated with a payment instruction if the first location data is within a predetermined distance of the second location data for the payment location (e.g., according to the payment location proximity detail discussed above.)

User 102 may release geo-location information to the service provider server 180 by, e.g., setting release parameters. In one aspect, the user geo-location information includes user information related to a physical location or position of the mobile device 132, which are passed to the service provider server 180 via the network 160. The user geo-location information may include GPS coordinates (e.g., longitude and latitude) inherent to the mobile device 132, such as a mobile cellular phone, and/or zip-code information. The user geo-location information may include user identifier information identifying the user 102. The user 102 may manually set geo-location information, such as a zip code and/or longitude and latitude coordinates.

At block 208, when user 102 is within a predetermined distance of one of the predetermined locations in the payment instruction, service provider server 180 automatically sends a payment request. In response to determining that mobile device 132 is in a payment location associated with a payment instruction, a payment request is automatically sent by service provider server 180 over the network 160 to mobile device 132 to make a payment from the user account designated in the payment instruction to the merchant designated in the payment instruction. User 102 receives the payment request and can confirm that payment should be made.

The payment request may include one or more payment details discussed above. For example, the payment request may include a payment amount that was included with the payment amount detail.

In another embodiment, mobile device 132 and/or service provider server 180 may apply the payment time period detail by retrieving a current time and determining if the current time is within a payment time period that was included with the payment time period detail. If the current time is within the payment time period, the payment request is sent, while if the current time is outside the payment time period, the payment request is not sent.

In yet another embodiment, mobile device 132 and/or service provider server 180 may apply the pay automatically detail and send the payment request automatically upon determining that mobile device 132 is a payment location that is associated with a payment instruction.

In one embodiment, the merchant device 120, mobile device 132 and/or service provider server 180 may apply the request confirmation before paying detail and provide a confirmation request to mobile device 132 before sending the payment request. For example, an alert may be provided on mobile device 132 that may include a payment confirmation section, a location indicator, a last payment indicator, and a send payment request button. The payment confirmation section includes a payment amount input that may be pre-populated with an amount that was provided in the payment instruction, that may be editable using mobile device 132 to provide a different payment amount, and/or that may be blank such that a payment amount must be provided using mobile device 132. User 102 may then provide, edit, and/or confirm the payment amount and the information in the alert and send the payment request by selecting the send payment request button.

In another embodiment, the service provider server 180 sends the payment request in the form of a QR code to the merchant device 120. A QR code is a two-dimensional barcode (2D barcode) that may be displayed by the merchant device 120 and scanned by a camera on the mobile device 132 to communicate between the two devices. User 102 scans the QR code with mobile device 132 and is directed to a page that requests payment confirmation. The QR code, which is associated with the payment request, allows details of the payment to be viewed or accessed through mobile device 132. Thus, user 102 can review the payment amount, payment location, merchant, etc. before confirming payment.

At block 210, service provider server 180 receives confirmation. At block 212, service provider server 180 processes the payment request. In response to receiving the payment confirmation, the service provider server 180 may transfer funds from the user account to the merchant, e.g., over the network 160.

Thus, a system and method for making payments based on predetermined locations is provided that allows a user to define locations, times, amounts, and other details of a payment. When a mobile device of the user is determined to be in a payment location in which the user has indicated they would like to make payments, a payment request may be sent to make a payment from a user account to a merchant. Such systems and methods allow a user to pay a merchant when the user is in the same location as the merchant or in a predetermined location.

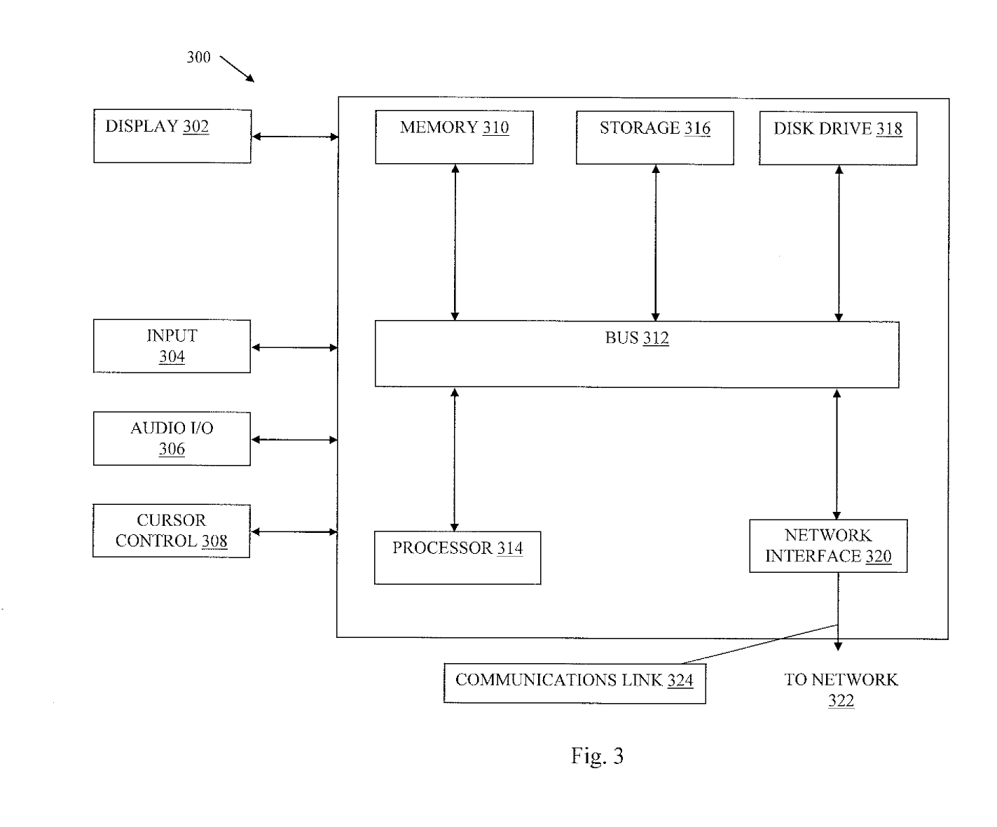

FIG. 3 is a block diagram of a computer system 300 suitable for implementing one or more embodiments of the present disclosure, including the merchant device 120, the mobile device 132, and the service provider server 180. In various implementations, the merchant device 120 may comprise a stand-alone computing device, such as an interactive computer terminal, the mobile device 132 may comprise a mobile cellular phone, personal computer (PC), laptop, PDA, etc. adapted for wireless communication, and the service provider server 180 may comprise a network computing device, such as a server. Thus, it should be appreciated that the devices 120, 132, 180 may be implemented as computer system 300 in a manner as follows.

Computer system 300 includes a bus 312 or other communication mechanism for communicating information data, signals, and information between various components of computer system 300. Components include an input/output (I/O) component 304 that processes a user (i.e., sender, recipient, third party and/or payment provider) action, such as selecting keys from a keypad/keyboard, selecting one or more buttons or links, etc., and sends a corresponding signal to bus 312. I/O component 304 may also include an output component, such as a display 302 and a cursor control 308 (such as a keyboard, keypad, mouse, etc.). An optional audio input/output component 306 may also be included to allow a user to use voice for inputting information by converting audio signals. Audio I/O component 306 may allow the user to hear audio. A transceiver or network interface 320 transmits and receives signals between computer system 300 and other devices, such as another user device, a merchant server, or a payment provider server via network 328. In one embodiment, the transmission is wireless, although other transmission mediums and methods may also be suitable. A processor 314, which can be a micro-controller, digital signal processor (DSP), or other processing component, processes these various signals, such as for display on computer system 300 or transmission to other devices via a communication link 324. Processor 314 may also control transmission of information, such as cookies or IP addresses, to other devices.

Components of computer system 300 also include a system memory component 310 (e.g., RAM), a static storage component 316 (e.g., ROM), and/or a disk drive 318. Computer system 300 performs specific operations by processor 314 and other components by executing one or more sequences of instructions contained in system memory component 310. Logic may be encoded in a computer readable medium, which may refer to any medium that participates in providing instructions to processor 314 for execution. Such a medium may take many forms, including but not limited to, non-volatile media, volatile media, and transmission media. In various implementations, non-volatile media includes optical or magnetic disks, volatile media includes dynamic memory, such as system memory component 310, and transmission media includes coaxial cables, copper wire, and fiber optics, including wires that comprise bus 312. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 324 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure.

1. A system, comprising:
a memory device storing user account information, wherein the user account information comprises the financial account information of the user and the user's predetermined route of travel including a first location and a second location; and
one or more processors in communication with the memory device and operable to:
receive payment instructions for making a first payment to a first merchant at the first location and a second payment to a second merchant at the second location;
determine a location of the user;
automatically transmit a first payment request when the user is within a first predetermined distance from the first location and automatically transmit a second payment request when the user is within a second predetermined distance from the second location;
receive a payment confirmation from the user in response to the first or the second payment request; and
process the first or the second payment request.

2. The system of claim 1, wherein the one or more processors is further operable to compare the location of the user with location data that is associated with a predetermined location, and determine that the location of the user is within a predetermined distance of the predetermined location.

3. The system of claim 1, wherein the payment instruction designates a first payment time period and a second payment time period, and
wherein the first payment request is sent when the user is within the first predetermined distance from the first location during the first payment time period and the second payment request is sent when the user is within the second predetermined distance from the second location during the second payment time period.

4. The system of claim 3, wherein the one or more processors is further operable to retrieve a current time and determine that the current time is within the first payment time period or the second payment time period.

5. The system of claim 1, wherein the payment instruction designates a payment amount for at least one of the first and the second location.

6. The system of claim 1, wherein at least one of the first and the second payment request is transmitted to the user or to a merchant.

7. The system of claim 6, wherein at least one of the first and the second payment request is transmitted to the merchant in the form of a QR code, and the user confirms payment by scanning the QR code.

8. A method of making payments during travel, comprising:
receiving payment instructions for making a first payment to a first merchant at a first location along a travel route of a user and a second payment to a second merchant at a second location along the travel route of the user;
determining, by one or more hardware processors of a service provider, a location of the user;
automatically transmitting, by one or more hardware processors of a service provider, a first payment request when the user is within a first predetermined distance from the first location and automatically transmit a second payment request when the user is within a second predetermined distance from the second location;
receiving a payment confirmation from the user in response to the first or the second payment request; and
processing the first or the second payment request.

9. The method of claim 8, further comprising comparing the location of the user with location data that is associated with a predetermined location, and determining that the location of the user is within a predetermined distance of the predetermined location.

10. The method of claim 8, wherein the payment instruction designates a first payment time period and a second payment time period, and
wherein the first payment request is sent when the user is within the first predetermined distance from the first location during the first payment time period and the second payment request is sent when the user is within the second predetermined distance from the second location during the second payment time period.

11. The method of claim 10, further comprising retrieving a current time and determining that the current time is within the first payment time period or the second payment time period.

12. The method of claim 8, wherein the payment instruction designates a payment amount for at least one of the first and the second location.

13. The method of claim 8, wherein at least one of the first and the second payment request is transmitted to the user or to a merchant.

14. The method of claim 13, wherein at least one of the first and the second payment request is transmitted to the merchant in the form of a QR code, and the user confirms payment by scanning the QR code.

15. A non-transitory machine-readable medium comprising a plurality of machine-readable instructions which, when executed by one or more processors, are adapted to cause the one or more processors to perform a method comprising:
receiving payment instructions for making a first payment to a first merchant at a first location along a travel route of a user and making a second first payment to a second merchant at a second location along the travel route of the user;
determining a location of the user;
automatically transmitting a first payment request when the user is within a first predetermined distance from the first location and automatically transmitting a second payment request when the user is within a second predetermined distance from the second location;
receiving a payment confirmation from the user in response to the first or the second payment request; and
processing the first or the second payment request.

16. The non-transitory machine-readable medium of claim 15, wherein the method further comprises:
comparing the location of the user with location data that is associated with a predetermined location, and
determining that the location of the user is within a predetermined distance of the predetermined location.

17. The non-transitory machine-readable medium of claim 15, wherein the payment instruction designates a first payment time period and a second payment period, and
wherein the first payment request is sent when the user is within the first predetermined distance from the first location during the first payment time period and the second payment request is sent when the user is within the second predetermined distance from the second location during the second payment time period.

18. The non-transitory machine-readable medium of claim 17, wherein the method further comprises:
retrieving a current time; and
determining that the current time is within the first payment time period or the second payment time period.

19. The non-transitory machine-readable medium of claim 15, wherein at least one of the first and the second payment request is transmitted to the user or to a merchant.

20. The non-transitory machine-readable medium of claim 19, wherein at least one of the first and the second payment request is transmitted to the merchant in the form of a QR code, and the user confirms payment by scanning the QR code.
